(19) United States
(12) Patent Application Publication
(10) Pub. No.: US 2011/0015874 A1
(43) Pub. Date: Jan. 20, 2011

(54) APPARATUS AND METHOD FOR DETECTING COMPONENTS OF MIXED GAS

(76) Inventor: Yong-Won SONG, Daejeon (KR)

Correspondence Address: FROMMER LAWRENCE & HAUG LLP, 745 FIFTH AVENUE, NEW YORK, NY, 10151, US

(21) Appl. No.: 12/608,623

(22) Filed: Oct. 29, 2009

(30) Foreign Application Priority Data
Jul. 16, 2009 (KR) 10-2009-0065094

(51) Int. Cl. G01N 21/00; G06F 19/00

(52) U.S. Cl. 702/24; 250/573; 977/742; 977/957

(57) ABSTRACT

The present invention provides an apparatus and method for detecting components of a mixed gas which increases the detection efficiency using a sensor array in which various types of nanomaterials such as carbon nanotubes (CNT), zinc oxide (ZnO), titanium dioxide (TiO₂), and tin dioxide (SnO₂) which are sensitive to environment, so as to detect various components of a mixed gas using the characteristics that the effective refractive index change of the sensors induced by the gas adsorption depends on the apecies of nanomaterials and a concentration change in detected materials, thus effectively detecting the components of a mixed gas by the single detection without an inefficient education process required for conventional pattern recognition.

For this purpose, the present invention provides an apparatus for detecting components of a mixed gas, in which a plurality of optical fiber sensors such as D-shaped optical fiber Bragg grating sensors, long period grating sensors, and Fabry-Perot optical fiber sensors in which nanomaterials are patterned or coated on an side or end of each optical fiber are used. In the case of the D-shaped optical fiber sensor, nanomaterials such as carbon nanotubes (CNT), zinc oxide (ZnO), titanium dioxide (TiO₂), and tin dioxide (SnO₂) are coated on a flat surface of a core region, thus forming an optical fiber sensor array including a plurality of optical fiber sensors formed with different nanomaterials such that the cross-section of the D-shaped optical fiber senor is oriented outwardly to be exposed to a detected material. In the case of the Fabry-Perot optical fiber sensor, nanomaterials are coated on an end of each optical fiber, thus forming an optical fiber sensor array. Moreover, the present invention provides a method for detecting components of a mixed gas, which can qualitatively and quantitatively measure a mixed gases by calculating the characteristics of a optical waveform, i.e., a wavelength shift and a change in intensity of the waveform, reflected or transmitted by a change in refractive index caused a detected material is adsorbed by the coated nanomaterials while an optical signal from a pulse laser passes through an optical fiber.

### CROSS-REFERENCE TO RELATED APPLICATION

This application claims under 35 U.S.C. §119(a) the benefit of Korean Patent Application No. 10-2009-0065094 filed Jul. 16, 2009, the entire contents of which are incorporated herein by reference.

### BACKGROUND

(a) Technical Field

The present invention relates to an apparatus and method for detecting components of a mixed gas and, more particularly, to a method and apparatus which is configured to quantify the species and content of a mixed gas using an optical fiber sensor array in which various types of nanomaterials are introduced.

(b) Background Art

With the development of science and industry, the amount of toxic gases produced has increased to cause various environmental pollution problems which threaten the existence of human beings. Therefore, many countries have enforced or proposed regulations on exhaust gas from various devices for both home and industrial purposes, and thus the problem of exhaust gas has become more important these days.

Accordingly, in the regulations on exhaust gas, there is a need for an apparatus that can accurately detect a mixed gas consisting of various gas components, thus detecting toxic gas components from the exhaust gas. Conventionally, a sensor that operates based on current change is used as a gas detector for the gas components. However, this type of sensor has the problems related to the maintenance and repair and the energy supply for operating the sensor in the field.

In connection with this, in the cases of a semiconductor gas sensor using a thin film or nanostructure and a gas sensor using MEMS technology, which are widely used at present, the detection is made in such a manner to detect a change in current using the characteristics that the electrical conductance or resistance is changed according to the absorption of gas molecules. Thus, there are technical limitations in ensuring an electrical energy source in the field, maintenance or repair, and aging of the sensor, and there is a problem of requiring a complicated semiconductor process.

Moreover, these types of existing sensors, which are configured so as to detect one kind of gas with the use of a single sensor, have the problem that the sensitivity and discriminability are significantly reduced when being applied to a mixed gas, and thus detecting only one gas component from the mixed gas.

Meanwhile, a conventional multi-sensing technology for detecting a mixed gas is related to a software approach which requires a pattern recognition process via a repetitive learning process for a long time with respect to a plurality of detection signals for corresponding gas components. Thus, the conventional multi-sensing technology has a significant limitation in the amount of signals to be process and the signal processing speed. Moreover, in the case where an initially learned program is used due to aging of the sensor, the detection accuracy is significantly reduced, which causes a problem in practical use. Furthermore, there is a fundamental problem that an overload is imposed on the software depending upon the various kinds of gases, and thus it is difficult to expect the effect of pattern recognition.

The above information disclosed in this background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. Accordingly, the present invention provides an apparatus and method for detecting components of a mixed gas which increases the detection efficiency using a sensor array in which various types of nanomaterials such as carbon nanotubes (CNT), which are sensitive to environment, so as to detect various components of a mixed gas using the characteristics that the effective refractive index change of the sensors induced by the gas adsorption depends on the type of nanomaterials., thus effectively detecting the components of a mixed gas by the single detection without an inefficient education process required for pattern recognition.

Moreover, the present invention provides an apparatus and method for detecting components of a mixed gas, which can accurately and quickly acquire information on the multi-components of the gas by performing a calculation based on the information obtained from an optical fiber sensor array.

In one aspect, there is provided an apparatus for detecting components of a mixed gas, the apparatus including: an optical fiber sensor array including n-number (n≧2) of optical fiber sensors formed with different nanomaterials having different refractive index changes according to species of detected gases; a conversion unit for converting an optical signal obtained from the optical fiber sensor array into an electric signal; a data storage unit for storing data related to an initial refractive index of each optical fiber sensor and a change rate of the refractive index of the sensors; and a calculation unit for calculating a changed refractive index from the electrical signal converted by the conversion unit and estimating species and contents of a mixed gas from an equation formed by the changed refractive index, the initial refractive index of the optical fiber sensors, and the change rate of the refractive index from the data storage unit.

The optical fiber sensor array may include n-number (n≧2) of optical fiber sensors formed in such a manner that nanomaterials are patterned on a flat surface of a D-shaped optical fiber in the form of a Bragg grating or long period grating.

The optical fiber sensor array may include n-number (n≧2) of optical fiber sensors formed in such a manner that nanomaterials are coated on an end of an optical fiber in the form of a thin film, thereby forming a Fabry-Perot device.

The nanomaterials may be one selected from the group consisting of carbon nanotubes (CNT), zinc oxide (ZnO), titanium dioxide (TiO₂), and tin dioxide (SnO₂).

The optical fiber sensor array may include a plurality of optical fiber sensors sequentially arranged such that a grating surface of the D-shaped optical fiber sensor is exposed to the detected material.

The optical fiber sensor array may include a plurality of optical fiber sensors arranged in a gathered shape such that a grating surface of the D-shaped optical fiber sensor is exposed to the detected material.

The calculation unit may sequentially perform a calculation for the case that the number of solutions of the equation is 1, 2, . . . , n−1, in which if a negative solution is obtained, the negative solution is discarded, and if there exists a positive solution, terminate the calculation.

The apparatus for detecting the components of a mixed gas in accordance with the present invention may further include a time delay lines connected to the conversion unit so as to distinguish each optical signal reflected by the n-number (n≧2) of optical fiber sensors of the optical fiber sensor array.

The time delay lines may include a plurality of optical fibers connected from each of the optical fiber sensor to the conversion unit and each having a different length.

The apparatus for detecting the components of a mixed gas in accordance with the present invention may further include an output unit for outputting data related to the species and content of a mixed gas calculated by the calculation unit.

In another aspect, there is provided a method for detecting components of a mixed gas, the method including: storing data related an initial refractive index of each optical fiber sensor including a plurality of optical fiber sensors and a change rate of the refractive index of the sensors; measuring an optical signal transmitted from a light source and changed by the optical fiber sensor array; converting the optical signal into an electrical signal; and estimating species and content of a mixed gas by calculating a changed refractive index from the electrical signal and solving an equation formed by the initial refractive index of the optical fiber sensors and the change rate of the refraction index from a data storing unit.

The method for detecting the components of a mixed gas in accordance with the present invention may further include providing a different time delay to each optical signal obtained from the optical fiber sensor array so as not to interfere with each other before converted into the electrical signal.

The method for detecting the components of a mixed gas in accordance with the present invention may further include outputting data related to the calculated species and content of a mixed gas to the outside.

In the estimating of the species and content of a mixed gas, a calculation may be sequentially performed for the case that the number of solutions of the equation is 1, 2, . . . , n−1, and n and, if there exists a solution, the calculation may be terminated.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing an apparatus for detecting components of a mixed gas in accordance with the present invention;

FIG. 2 is a perspective view showing an example of an optical fiber sensor in accordance with the present invention;

FIG. 3 is a perspective view showing another example of an optical fiber sensor in accordance with the present invention;

FIG. 4 is a schematic diagram showing a concrete arrangement of optical fiber sensors in an optical fiber sensor array in accordance with the present invention;

FIG. 5 is a schematic diagram showing a detection part for a transmission-type sensor in the apparatus for detecting components of a mixed gas in accordance with the present invention; and

FIG. 6 is a flowchart illustrating a method for detecting components of a mixed gas in accordance with the present invention.

### DETAILED DESCRIPTION

The present invention provides an apparatus and method for detecting components of a mixed gas, which converts an optical signal, obtained from an optical fiber sensor array in which a detection part is patterned with nanomaterials such as carbon nanotubes (CNT), zinc oxide (ZnO), titanium dioxide (TiO₂), or tin dioxide (SnO₂) into an electrical signal and converts the electrical signal into a digital signal so as to effectively detect the species and content of a mixed gas by obtaining solutions of simultaneous equation via a predetermined calculation process of a calculation unit from pre-stored data and detected data.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Hereinafter, an apparatus and method for detecting components of a mixed gas in accordance with preferred embodiments of the present invention will be described in detail with reference to the accompanying drawings.

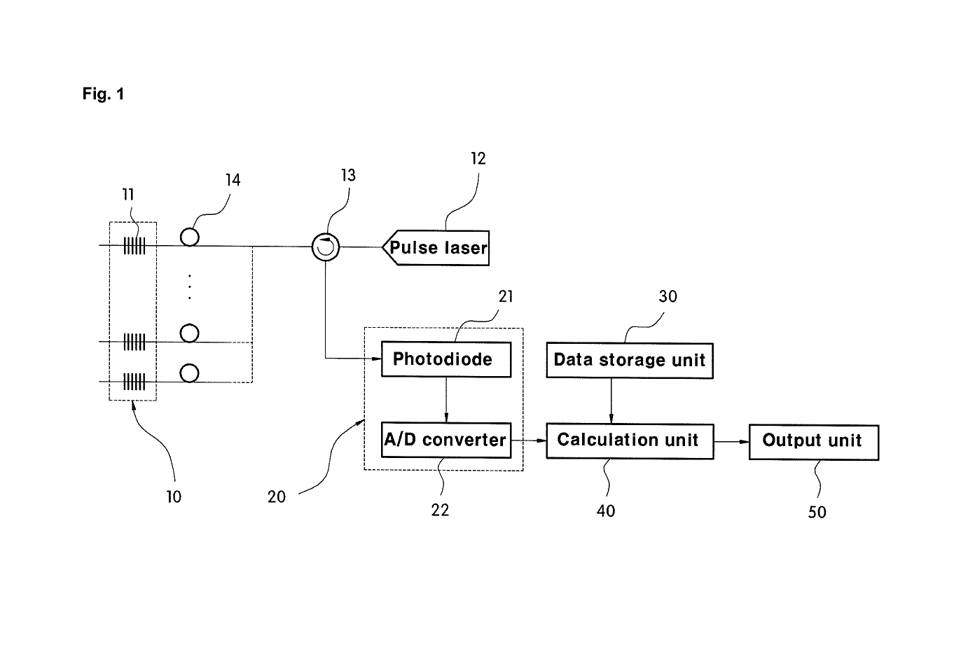

FIG. 1 is a schematic diagram showing an apparatus for detecting components of a mixed gas in accordance with the present invention

As shown in FIG. 1, the apparatus for detecting components of a mixed gas in accordance with the present invention comprises a detecting part including a pulse laser 12, an optical fiber sensor array 10 consisting of a plurality of optical fiber sensors 11, and a converter 20, and a measuring part including a calculation unit 40 for calculating information on components of a mixed gas from an electrical signal transmitted from the detection part.

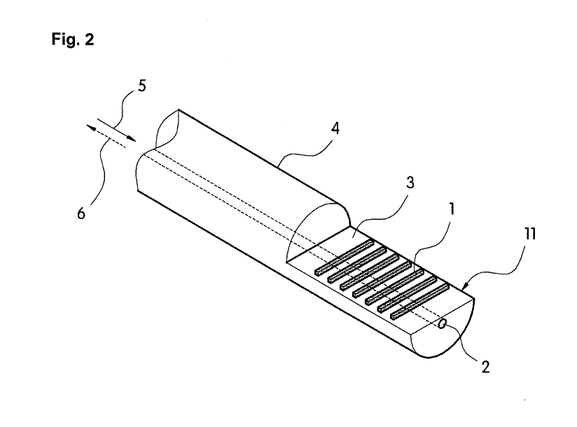

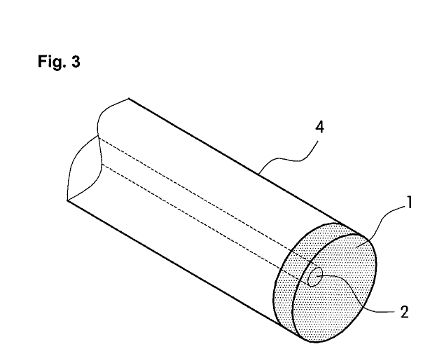

The optical fiber sensors, which can be used in the apparatus for detecting components of a mixed gas in accordance with the present invention, may include a D-shaped optical fiber Bragg grating sensor, a long period grating sensor, and a Fabry-Perot optical fiber sensor in which nanomaterials are coated on an side or end of each optical fiber, and the structures of these optical fiber sensors are shown in FIGS. 2 and 3.

FIG. 2 shows the structure of a D-shaped optical fiber Bragg grating sensor which is applicable to the present invention. As shown in FIG. 2, the D-shaped optical fiber Bragg grating sensor used in the present invention is formed by coating nanomaterials 1 on a flat section 3, formed by removing a part of a cladding 4 from an optical fiber including a core 2 and the cladding 4, in the grating shape along the axial direction of the optical fiber core 2. An optical signal 5 transmitted from the pulse laser 12 is used to generate a detection signal 6 corresponding to an optical signal selected by the grating patterned with the nanomaterials 1. Moreover, a long period grating sensor as a transmission-type sensor may be configured to measure the detection signal.

Meanwhile, as shown in FIG. 3, the optical fiber sensor used in the present invention may be configured as a Fabry-Perot optical fiber sensor in which nanomaterials 1 are coated on an end of each optical fiber in the form of a thin film so as to measure the detection signal 6 reflected by the thin film of the nanomaterials 1.

Next, the apparatus for detecting components of a mixed gas in accordance with the present invention, which is configured with the optical fiber Bragg grating sensors will be described in detail.

As shown in FIG. 1, the apparatus for detecting components of a mixed gas in accordance with the present invention is configured in such a manner that an optical signal generated from the pulse laser 12 is transmitted to the optical fiber sensor array 10 including the plurality of optical fiber sensors 11 via a circulator 13. The circulator 13 controls the optical signal applied from the pulse laser 12 to be transmitted to the optical fiber sensors 11 and the detection signal reflected by the optical fiber sensors 11 to be transmitted to the converter 20. Preferably, a time delay lines 14 may be connected between the optical fiber sensor array 10 and the circulator 13 such that there is no interference between the detection signals reflected by each of the plurality of optical fiber sensors 11, thus transmitting accurate detection signals. The time delay lines 14 controls the time during which the detection signals from the optical fiber sensors 11 are transmitted to the converter 20 via the circulator 13 so as to introduce a relative time delay. Preferably, the time delay lines 14 may be implemented by adjusting the lengths of the connected optical fibers without the use of any equipment.

Meanwhile, the detection signal reflected by the optical fiber sensor array 10 is transmitted to the converter 20 via the time delay lines 14 and the circulator 13. The converter 20 is configured to convert the transmitted optical signal into an electrical signal suitable for the calculation. Preferably, the converter 20 may include a photodiode 21 for converting an optical signal into an electrical signal and an analog/digital (ND) converter 22 for converting an analog signal into a digital signal.

The electrical digital signal converted by the converter 20 is transmitted to the calculation unit 40. The calculation unit 40 calculates the species and content of a mixed gas from an equation based on the transmitted digital signals and data related to an initial refractive index of each optical fiber sensor input in advance to a data storage unit 30 and a change rate of the refractive index for each of various gas components. Moreover, the apparatus for detecting components of a mixed gas in accordance with the present invention may include an output unit 50 for outputting the calculated species and content of a mixed gas to the outside.

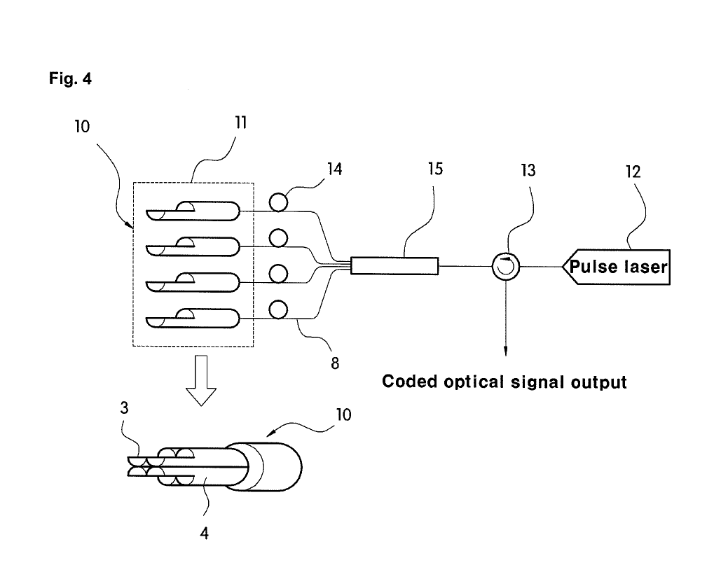

FIG. 4 shows a detailed structure of a detection part in the apparatus for detecting components of a mixed gas in accordance with the present invention, in which the structure of the optical fiber sensor array 10 is shown in detail.

The optical fiber sensor array 10 in accordance with the present invention, as shown in the top of FIG. 4, may have a structure in which a plurality of optical fiber sensors 11 are sequentially arranged.

Moreover, in the apparatus for detecting components of a mixed gas in accordance with the present invention, the optical fiber sensor array 10 may be configured as an optical fiber sensor array in which the grating surface of each of the D-shaped optical fiber Bragg grating sensors is oriented outwardly to create a gathered shape. This type of optical fiber sensor array can effectively detect the components of a mixed gas by a limited detection operation. Moreover, the apparatus for detecting components of a mixed gas in accordance with the present invention may include a combiner 15 which combines the detection signals transmitted to the optical fiber sensor array and passing through the time delay lines 14 and transmits the combined signal to the converter.

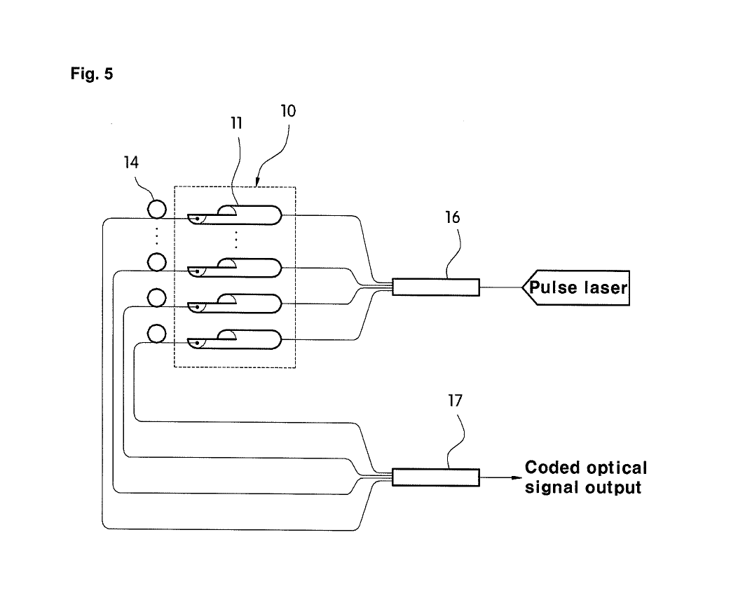

FIG. 5 shows a detailed structure of a detection part in which a long period grating sensor as a transmission-type sensor is used in the apparatus for detecting components of a mixed gas in accordance with the present invention. As shown in FIG. 5, an optical fiber line including a combiner 17 for combining the detection signals and transmitting the combined signal to the converter is provided so as to output the optical signal transmitted and detected.

Meanwhile, in the case of the apparatus for detecting components of a mixed gas including the optical fiber grating sensors, a process of deriving simultaneous equations and a process of calculating solutions of these simultaneous equations, which are used to describe the process in which the calculation unit analyzes the species and content of a mixed gas, will be described below.

In the case of the optical fiber Bragg grating (FBG) sensors, a reflection wavelength λ_{B} is determined by a refractive index n of the grating and a grating period Λ as represented by the following equation 1:

λ_{B}=2nΛ [Equation 1]

If the grating period of nanomaterials is ˜500 nm, an optical fiber Bragg grating sensor in which the reflection occurs at a wavelength of ˜1,550 nm can be manufactured. The waveform of the reflected wavelength is determined by the above equation 1 and, since the refractive index of the grating is changed when gas molecules are adsorbed onto the nanomaterials, it is possible to find a change in the refractive index of the nanomaterials, which form the grating, due to the detected material by detecting a change in the intensity of a reflected pulse which moves away from the center of the spectrum of incident light due to a change in the wavelength of the reflected light.

Although the optical signals output from the respective optical fiber sensors pass through the time delay lines and are combined by the combiner, the detection signals output from the respective optical fiber sensors are naturally coded when the reflected signals are divided by different time delays and then combined by setting the time delay lines in a different manner as follows:

Time delay line with an optical fiber of 1 cm→Time delay of 100 ps; and

Time delay line with an optical fiber of 2 cm→Time delay of 200 ps.

In the spectrum of the pulse, when a soliton with a full-width half-maximum (FWHM) of more than I (2 σ) is approximated to a Gaussian function, the intensity of reflected light can be represented by the following equation 2:

$${I}_{out} = {I}_{0} exp [ - \frac{{( {λ}_{B} - {λ}_{0} )}^{2}}{{2}^{σ 2}} ] \qquad [ Equation 2 ]$$

wherein I₀ represents the intensity of reflected light in the case of λ₀, i.e., when there is no detected material, 2 σ represents the FWHM value, and λ_{B} represents the wavelength of reflected light determined by equation 1.

n may be obtained by substituting equation 1 into equation 2 as represented by the following equation 3:

$$n = \frac{1}{2 Λ} ( {λ}_{0} + {[ {2}_{σ}^{2} ln ( \frac{{I}_{0}}{{I}_{out}} ) ]}^{1 / 2} ) \qquad [ Equation 3 ]$$

Since the refractive index by the detected material always increases, the value of [2 σ²In(I₀/Iₒᵤₜ)]^{1/2} is a positive number.

In connection with equation 3, if the refractive index varies linearly when the concentration of the detected material increases, the refractive index can be represented by the following equation 4:

nᵢ=s·σ+n₀ᵢ [Equation 4]

wherein nᵢ represents the refractive index of each optical fiber sensor using specific nanomaterials, s represents the change rate of the refractive index based on an increase in the concentration of each material due to adsorption on the specific nanomaterials (slope of refractive index vs concentration curve), and σ represents the amount of each gas component which causes the change in the refractive index.

Here, σ is differently given as x, y, z, ω, etc. according to the kinds of the detected materials.

The relationships between the amount (σ) of each gas component and the changed refractive index (nᵢ) of the nanomaterials coated on each optical fiber sensor are shown in the following graph, in which n₀ᵢ represents the initial refractive index of each optical fiber sensor:

wherein A, B, C, and D represents the different types of gas components. It can be seen that the refractive index varies in a different manner with respect to the initial refractive index of each optical fiber sensor due to the different change rates of the different refractive indexes according to the independent change in the amount (σ) of each different gas component.

As such, the change rate (s) of the refractive index of each different gas component is given as aᵢ, bᵢ, cᵢ, and dᵢ, and the change rate of the refractive index corresponding to each optical fiber sensor having different nanomaterials can be measured as aᵢ, bᵢ, cᵢ. and dᵢ (i=1, 2, 3, and 4).

For example, when configuring an optical fiber sensor array including four optical fiber sensors for detecting four kinds of materials in the method for detecting components of a mixed gas in accordance with the present invention, σ corresponds to x, y, z, and ω with regard to the respective materials and s corresponds to ai, bi, ci, and di (I=1, 2, 3, and 4). Therefore, the refractive indices obtained from the four individual sensors can be represented by the following equation 5:

p₁→n₁=a₁x+b₁y+c₁z+d₁ω+n₀₁

p₂→n₂=a₂x+b₂y+c₂z+d₂ω+n₀₂

p₃→n₃=a₃x+b₃y+c₃z+d₃ω+n₀₃

p₄→n₄=a₄x+b₄y+c₄z+d₄ω+n₀₄ [Equation 5]

Here, s has different values, which can be implemented during the manufacturing of the optical fiber sensor array using different types of nanomaterials for each sensor such that the change rates of the refractive indices are different from each other by the different detected materials.

When the values of coefficients x, y, z, and ω in equation 5 are arranged in a matrix M, the above equation 5 can be represented by the following equation 6:

$$M [ \begin{matrix}x \\ y \\ z \\ ω\end{matrix} ] = [ \begin{matrix}{n}_{1} - {n}_{01} \\ {n}_{2} - {n}_{02} \\ {n}_{3} - {n}_{03} \\ {n}_{4} - {n}_{04}\end{matrix} ] \qquad [ Equation 6 ]$$

The values of the gas components x, y, z, and ω can be obtained by the following equation 7:

$$[ \begin{matrix}x \\ y \\ z \\ ω\end{matrix} ] = {M}^{- 1} [ \begin{matrix}{n}_{1} - {n}_{01} \\ {n}_{2} - {n}_{02} \\ {n}_{3} - {n}_{03} \\ {n}_{4} - {n}_{04}\end{matrix} ] \qquad [ Equation 7 ]$$

A process of calculating equation 7 may be performed by a computer program which undergoes the following steps 1 to 4. The following steps are performed so as not to obtain a negative solution, which does not exist actually, with respect to a solution representing the amount of the corresponding gas. The calculation is repeatedly performed until a positive solution is obtained by discarding the negative solution obtained, and therefore it is possible to obtain an accurate solution for the gas components.

[Step 1]

p₁→n₁=a₁x+b₁y+c₁z+d₁ω+n₀₁

p₂→n₂=a₂x+b₂y+c₂z+d₂ω+n₀₂

p₃→n₃=a₃x+b₃y+c₃z+d₃ω+n₀₃

p₄→n₄=a₄x+b₄y+c₄z+d₄ω+n₀₄

First, under the assumption that equation 5 has a single solution, a process of obtaining solutions of simultaneous equations is performed and, in this case, when the four equations p₁, p₂, p₃, and p₄ have a single solution x, variables y, z, and ω are equal to 0 (y=z=ω=0), which means that the mixed gas consists of one kind of gas.

If the four equations p₁, p₂, p₃, and p₄, do not have the same solution x, the calculation is performed based on the case of x=z=ω=0 to determine whether the variables y obtained from the four equations are the same as each other. Here, if the variables y are not the same as each other, the same step is carried out with respect to other variables z and ω to determine whether a single gas exists.

[Step 2]

The number of cases to select two equations so as to obtain the values of x and y using the four equations p₁, p₂, p₃, and p₄ is six (6) and, here, z=ω=0. If the values of six pairs of x and y obtained by performing the calculation six times are the same as each other, it can be determined that two kinds of gases are present.

Since the number of cases in which two positive number values other than zero (0) are present in the variables of x, y, z, and ω is six (6), when the calculation is sequentially performed under the assumption that two variables out of x, y, z, and ω are zero (0), the calculation is performed repeatedly thirty six (36) times.

The species and amounts of two kinds of gases can be known by performing the above calculation.

[Step 3]

The number of cases to select three equations so as to obtain the values of x, y, and z using the four equations p₁, p₂, p₃, and p₄ is four (4) and, if the values of four pairs of x, y, and z are the same as each other, it can be determined that three kinds of gases are present.

Since the number of cases in which three positive number values other than zero (0) are present in the variables of x, y, z, and ω is four (4), when the calculation is sequentially performed until the solutions are obtained, the calculation is performed sixteen (16) times.

[Step 4]

In this step, in the case that no solution is obtained from the above steps 1 to 3, the final calculation is performed using equation 7, in which it is determined that the mixed gas consists of four gas components, to find the values of x, y, z, and ω.

In step 1, the calculation for obtaining a solution of the linear equation is performed sixteen (16) times, and in steps 2 to 4, the calculation is repeated 36+16+1 times using the determinant, thus completing the analysis of the detection.

Although the calculation is intended to perform steps 1 to 4, once the solution is obtained, the calculation is terminated and the solution is output. In order to identify the kinds of gas components, the characteristics of the refractive index changes according to an increase in the volume with respect to all combinations of gas components should be input in advance. Since the change in the refractive index due to the combinations of gas components has linear characteristics, it is possible to determine the measurement range of the sensors within the linear range of the countable values.

The number of individual sensors may be expanded to N number, and it is possible to detect a mixed gas consisting of various kinds of gas components using the same method. When writing a computer program, the initial conditions are set such that the values of x, y, z, and w have positive values at all times, and Matrix M which are the values of coefficients σ as a gradient matrix should have an inverse matrix, which can be manually set during the manufacturing the sensors.

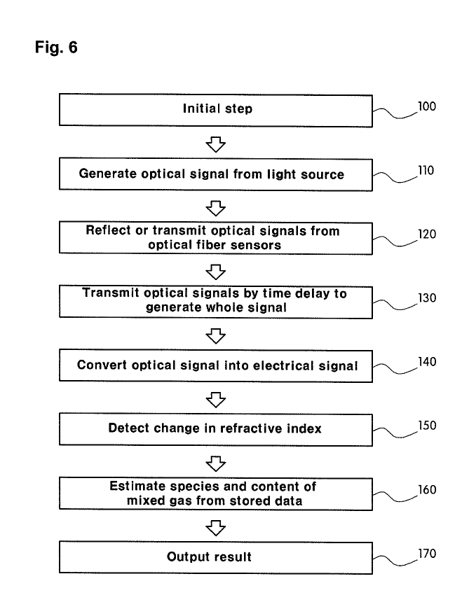

FIG. 6 is a flowchart illustrating a method for detecting components of a mixed gas in accordance with the present invention.

As illustrated in FIG. 6, the method for detecting components of a mixed gas in accordance with the present invention includes initial step 100 of storing data related to an initial refractive index of the optical fiber sensors and a change rate of the refraction index of the sensors, step 110 of generating an optical signal from the pulse laser as a light source, step 120 of measuring the optical signal changed by the plurality of individual optical fiber sensors, step 130 of transmitting the optical signals by the time delay lines to generate a whole signal, step 140 of converting the optical signal into an electrical signal, step 150 of detecting a changed refractive index from the electrical signal, step 160 of estimating the species and content of a mixed gas by solving simultaneous equations formed by the initial refractive index of the optical fiber sensors and the change rate of the refraction index from the data storing unit and outputting the estimated species and content.

Especially, step 160 of estimating the species and content of a mixed gas is performed through the calculation process for obtaining solutions of the simultaneous equations in the above-described manner, through which it is possible to detect the species and content of a mixed gas by the single measurement with high accuracy and precision.

As described above, the apparatus and method for detecting the components of a mixed gas in accordance with the present invention provides the following effects.

According to the present invention, it is possible to analyze the components of a mixed gas by a single detection module and estimate the species and content of a mixed gas, thus providing high efficient and high sensitive detection. Since all of the local sensors are operated under the central control and do not require local power, it is possible to significantly reduce the power consumption. Moreover, with the use of nanomaterials, it is possible to significantly increase the sensitivity of the sensors. Furthermore, since the detection module can be simply replaced, it is possible to facilitate the maintenance and repair.

The gas sensor using optical signals can solve the problems of the currently used bulk-type gas sensor, which is operated at high temperature (e.g., several hundred degrees Celsius) and thus has a short durability due to deterioration and overcome the risk of gas explosion due to the detection current, thus it is possible to ensure a safe and effective detection, which is not affected by peripheral environment.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for detecting components of a mixed gas, the apparatus comprising:
an optical fiber sensor array including n-number (n≧2) of optical fiber sensors formed of different nanomaterials having different refractive indices according to adsorption of detected materials;
a conversion unit for converting an optical signal obtained from the optical fiber sensor array into an electric signal;
a data storage unit for storing data related to an initial refractive index of the optical fiber sensors and a change rate of the refractive index of the sensors; and
a calculation unit for calculating a changed refractive index from the electrical signal converted by the conversion unit and estimating species and content of a mixed gas from an equation formed by the changed refractive index, the initial refractive index of the optical fiber sensors, and the change rate of the refractive index from the data storage unit.

2. The apparatus of claim 1, wherein the optical fiber sensor array comprises n-number (n≧2) of optical fiber sensors formed in such a manner that nanomaterials are patterned on a flat surface of a D-shaped optical fiber in the form of a Bragg grating or long period grating.

3. The apparatus of claim 1, wherein the optical fiber sensor array comprises n-number (n≧2) of optical fiber sensors formed in such a manner that nanomaterials are coated on an end of an optical fiber in the form of a thin film.

4. The apparatus of claim 2, wherein the nanomaterials comprises one selected from the group consisting of carbon nanotubes (CNT), zinc oxide (ZnO), titanium dioxide (TiO₂), and tin dioxide (SnO₂).

5. The apparatus of claim 2, wherein the optical fiber sensor array comprises a plurality of optical fiber sensors sequentially arranged such that a grating surface of the D-shaped optical fiber sensor is exposed to the detected material.

6. The apparatus of claim 2, wherein the optical fiber sensor array comprises a plurality of optical fiber sensors arranged in a gathered shape such that a grating surface of the D-shaped optical fiber sensor is exposed to the detected material.

7. The apparatus of claim 1, wherein the calculation unit sequentially performs a calculation for the case that the number of solutions of the equation is 1, 2, . . . , n−1, and n and, if there exists a solution, terminates the calculation.

8. The apparatus of claim 1 further comprising a time delay lines connected to the conversion unit so as to distinguish each optical signal reflected by the n-number (n≧2) of optical fiber sensors of the optical fiber sensor array.

9. The apparatus of claim 8, wherein the time delay lines comprises a plurality of optical fibers connected from each of the optical fiber sensor to the conversion unit and each having a different length.

10. The apparatus of claim 1, further comprising an output unit for outputting data related to the species and content of a mixed gas calculated by the calculation unit.

11. A method for detecting components of a mixed gas, the method comprising:
storing data related an initial refractive index of an optical fiber sensors including a plurality of optical fiber sensors and a change rate of the refractive index of the sensors;
measuring an optical signal transmitted from a light source and changed by the optical fiber sensor array;
converting the optical signal into an electrical signal; and
estimating species and content of a mixed gas by calculating a changed refractive index from the electrical signal and solving an equation formed by the initial refractive index of the optical fiber sensor array and the change rate of the refraction index from a data storing unit.

12. The method of claim 11 further comprising providing a different time delay to each optical signal obtained from the optical fiber sensor array so as not to interfere with each other before converted into the electrical signal.

13. The method of claim 11 further comprising outputting data related to the calculated species and content of a mixed gas to the outside.

14. The method of claim 11, wherein in the estimating of the species and content of a mixed gas, a calculation is sequentially performed for the case that the number of solutions of the equation is 1, 2, . . . , n−1, and n and, if there exists a solution, the calculation is terminated.

15. The method of claim 12, wherein in the estimating of the species and content of a mixed gas, a calculation is sequentially performed for the case that the number of solutions of the equation is 1, 2, . . . , n−1, and n and, if there exists a solution, the calculation is terminated.

16. The method of claim 13, wherein in the estimating of the species and content of a mixed gas, a calculation is sequentially performed for the case that the number of solutions of the equation is 1, 2, . . . , n−1, and n and, if there exists a solution, the calculation is terminated.

17. The apparatus of claim 3, wherein the nanomaterials comprises one selected from the group consisting of carbon nanotubes (CNT), zinc oxide (ZnO), titanium dioxide (TiO₂), and tin dioxide (SnO₂).
